(19) United States
(12) Patent Application Publication
(10) Pub. No.: US 2012/0204153 A1
(43) Pub. Date: Aug. 9, 2012

(54) AUTOMATED TESTING ON MULTIPLE VIDEO GAME PLATFORMS

(75) Inventors: KELLY PETERSON, SALT LAKE CITY, UT (US); SETH BEHUNIN, WEST JORDAN, UT (US); FRASER GRAHAM, SALT LAKE CITY, UT (US)

(73) Assignee: DISNEY ENTERPRISES, INC., BURBANK, CA (US)

(21) Appl. No.: 13/020,959

(22) Filed: Feb. 4, 2011

(51) Int. Cl. G06F 9/44

(52) U.S. Cl. 717/124

(57) ABSTRACT

A system and method for performing external and automated testing of video game software. A video game testing system includes a testing farm with game platforms and a communications hub communicatively linked with the game platforms. The system includes test scripts stored in memory that each defines test functions to be performed on the game platforms. The test scripts are platform neutral such that they can be written once and run on game consoles regardless of hardware or software differences. The system includes a testing framework on a computer system communicatively linked with the communications hub. During operations, the testing framework selects one of the test scripts transmits test messages with test orders to a subset of the game platforms and receives back test data including crash data. The platforms may differ in configuration or be identical consoles and be concurrently used to efficiently perform a test.

### BACKGROUND

1. Field of the Description

The present description relates, in general, to video game development and communications between development tools and video game platforms, and, more particularly, to systems and methods for performing automated and remote testing of video games running on two or more game platforms. The testing is “remote” in the sense that a majority (if not nearly all) the testing software (e.g., a testing framework) is run on a computer or machine separate from the game hardware or console. The automated testing often will involve concurrent testing of one or more games loaded and running on multiple game consoles (e.g., a “testing farm”).

2. Relevant Background

The video game market has moved from a smaller niche market to a multi-billion dollar market. The demand for new video games is growing rapidly as the size and demographics of game players continues to expand. Development is complicated because video games used to be made for only one or two game platforms, but now there is a demand for video games that can be sold on numerous platforms including standalone game consoles, portable and desktop computers, handheld portable gaming devices, and other electronic devices such as cellphones, digital music players, and tablet computers (collectively termed “game platforms”). As a result, there is significant competition among game developers to create video games to meet the growing demand in a timely and efficient manner and, often, there is a requirement that each of these new games be able to run as desired (e.g., similarly) on differing game platforms, devices, or consoles.

Large-scale, commercial video games are typically created by large development teams with the development process taking one to three years and costing millions of dollars. A development team may include producers to oversee production, game designers, artists, programmers, level designers, sound engineers, and testers with some team members handling more than one role. The development team works in a collaborative manner to create game content (or game assets) and game code, which together may be thought of as a game application, which can be run by a gaming engine on a particular game platform to provide the game to a player.

For example, programmers may write new source code, artists may develop game assets such as characters or scene objects, coloring schemes, textures, 3D models of game elements, and the like, sound engineers may develop sound effects and music, writers may create character dialog, and level designers may create advanced and eye-catching levels. To support these team members, numerous game development tools, such as Microsoft XNA, Maya from Autodesk, Inc., and the like, are now available for use in designing and creating game content including creating and modeling characters and even for defining game logic (e.g., how high a character jumps, how much life does a character gain or lose based on a game event, how fast does a character or game element move, and so on). Additionally, each video game console or platform developer typically will make a software development kit (or SDK or devkit) available to game developers, and each SDK may include applications or tools that are useful in creating new video games. Each SDK may also include a communications library and/or interface (e.g., platform communications data) to facilitate communications with a game platform (e.g., the platform running a game under current development or running a built game for testing or use by a developer to see how a new character, asset, game parameter, or the like is working in the game).

Another ongoing challenge for video game developers is how to efficiently and effectively test newly created or modified video games (or game applications or game software). Testing is required to identify a variety of possible programming issues or deficiencies that may cause a game to fail to operate as intended by the developer. For example, a newly created level may fail to load properly, the addition of a set of characters may result in one or more characters being properly rendered, a modification implemented by a developer may cause the game to be displayed too slowly (e.g., at less than about 25 to 30 frames per second), and so on such that the testing may be thought of as functional and/or integration testing of the game code. Video game testing may also need to be performed over a period of time or during game play such that the testing may be thought of as “stability testing” of the game on a game platform. Testing is further complicated by the fact that each game may need to function on multiple game consoles or platforms, and stability testing may show that this is not the case. For example, a new level of a game developed for two differing game platforms may properly load on one of the game platforms but fail during loading of that same level on the other game platform. Hence, effective video game testing needs to involve testing the video game thoroughly on each game platform for which it is being developed for use.

Presently, testing of video games is extremely expensive and is becoming more expensive each year. In part, this increase in expense is due to the fact that consoles or game platforms are increasing in complexity and power each year, which leads to more and more complex game applications that try to fully utilize the processing speed, higher quality display, and other functions of the game platform to create more exciting game experiences. As a result, game code is becoming more complex, and with this increased code complexity comes numerous software defects or bugs.

These bugs or software problems may be found manually such as a human tester playing a new game on a platform who finds a problem during game play and reports the bug to the game developer. This manual process is very time consuming, expensive, and often ineffective as it the reporting often is subjective (e.g., based on the game player's skill levels, tastes, and expectations on whether a game is functioning “as desired”). Automated video game testing has been developed that addresses a number of the problems with manual testing. Automated video game testing may be less expensive, at least during the performance stages but not necessarily in the development stages, and it is typically much faster. If automated tests are properly engineered, they can be run 24 hours a day and can find defects in a much more directed manner than manual or human-based testing.

Unfortunately, there are a number of problems with use of automated testing in the video game industry. Since each video game is being developed for multiple game platforms, writing automated tests is often problematic because the tests each need to be written or developed specifically for each game platform. For example, a test engineer may write a test that involves loading a level of a game and would have to prepare a first test routine for a game console produced by a first company (such as one of the PlayStation® consoles distributed by Sony Computer Entertainment America LLC) and then also prepare a second test routine for a game console produced by a second company (such as an Xbox® console distributed by Microsoft). This duplication of programming efforts is time consuming and each new test may also have its own bugs that have to be identified and corrected.

Significantly, such automated testing involves test code being generated for each console, and the test code is run on the same machine or platform that is running the video game being tested. In other words, the tests come from within the video game software that runs on the video game platform or console. By embedding the test functions within the game, proper testing practices are violated as the testing environment is polluted or changed, which can create inaccurate test results. Specifically, a video game may be created that functions as desired on a platform until the platform hardware is also burdened with performing the test, which may result in the test reporting metrics differing from those occurring when the test software is removed from the platform (e.g., the test itself may impact the results of the automated test). In another example, central process unit (CPU) parameters may be reported that differ when the game application is run than when the game application with embedded test software is run on the platform or a frame rate per second (FPS) may be reduced when the test is being run in the background of the game. Complicated tests may require extra memory that could impact performance of the game platform and even cause it to crash.

Another problem with embedding a test on a game platform is that since the test is executed and performed on the game console or machine, the only way to report on whether the test succeeded or failed is for the console or platform to write a file. This is problematic because the platform may have suffered a fatal error in the middle of a test and the most important or critical test results or information typically is lost before it could be written to a file in the platform's memory. When properly written, this test data the is retrieved and processed to identify bugs in the game code. However, as is often the case, the stored test data file will not contain the critical information useful for improving stability (e.g., information concerning the status of the game or the game platform hardware at the point when a fatal error occurred). It is a time consuming, and often nearly impossible, process to parse through the test data file to try to determine if the test succeeded (was completed) or failed. Since the test data file is on the platform/console itself, a manual step was often required to collect the test data or logs so that they could later be processed, which further slows the process in a large testing environment with numerous test platforms/game consoles. Further, there is usually a manual (human-performed) task of translating the data into a “call stack,” which is often the most critical portion of the information that a programmer may use to figure out where and why the game code crashed and which can be a time-consuming and tedious task.

Hence, there remains a need for improved methods and systems for supporting automated testing of game applications or software during video game development. Preferably, such methods and systems would facilitate testing games created for use on a variety of differing video game platforms (e.g., test level loading of a game on two or more differing game consoles). Further, it is preferred that the testing methods and systems be adapted to better comply with testing protocols than prior automated testing by not significantly modifying the test environment (e.g., not polluting the test by altering operation of the platform hardware or the game itself).

### SUMMARY

The present description addresses the above problems by providing methods and systems for automating testing of video game software. An exemplary test system includes a testing framework (or suite of software) running on a test-hosting computer system or device that is communicatively linked with a plurality of game platform (e.g., the same or differing game consoles) via a communications hub. The hub runs a hub communications application or module that has access to the data or knowledge of how to connect and communicate with each video game platform in the testing system or network (e.g., has access to platform communication libraries (such as those provided with game platform SDKs or the like) that may be thought of as communication data sets or libraries). The testing framework may be operated by a test engineer such as via graphical user interface (GUI) to retrieve one or more test scripts from the test-hosting computer system's memory, and then process the script and issue test instructions/orders via the communications hub to a set of the game platforms. Tests may be started or initiated outside of GUI, too, such as with a command line interface, which may be useful for allowing the tests to be started as part of an unsupervised process (e.g., every 30 minutes perform a test script or the like). The game platforms perform the test steps/functions and return test results/data back to the testing framework, via the communications hub, for further processing.

In this manner, the testing methods and systems provide automated testing that is remote from the game platform or console running the game application so as to avoid changing the game environment and test results. Further, even if the execution of a test case results in a crash (e.g., it is not the running of the test itself that causes the crash but the game code executed as part of a test step that may cause a crash or other problem), the testing framework is unaffected and can tally the test run as a failure upon detection of loss of communication with a particular game platform. The test script may call for the concurrent running of the same test on a number of game platforms and/or the distribution of a single larger test over a number of game platforms (e.g., load Levels 1-3 on a first number of game platforms, load Levels 4-6 of the same game on a second number of game platforms, and so on). For example, four different game tests may be run on sets of four game platforms (e.g., a testing farm made up of 16 Xbox® consoles or the like). Using these 16 game platforms that are each running a built game or game under development to simultaneously perform one or more tests allows the developer to receive feedback about the stability of the video game software in one sixteenth of the time previously required. If a developer checks in or introduces code in the game that causes a crash in the game, the testing system is able to terminate a test and alert the developer of the crash (e.g., in several minutes rather than hours or days).

More particularly, a video game testing system is provided for externally testing game software (e.g., the main portion of the testing application is not run on a game console which would pollute the testing environment). The system includes a testing farm made up of a plurality of game platforms adapted to run a video game under development. The system also includes a communications hub communicatively linked with the game platforms, and a set of test scripts stored in memory, each of the test scripts defining a number of test functions to be performed on the game platforms (e.g., test scripts that are platform neutral such that they can be written once and run on nearly any type of game platform/console regardless of hardware/software differences).

The system further includes a testing framework running on a computer system that is communicatively linked with the communications hub. During operation of the system, the testing framework selects one of the test scripts (such as in response to tester/user input to initiate a test run on the testing farm or from a command line interface such as running a batch of tests that are set up to run nightly/off-hours or one every preset time period (e.g., once every 30 minutes to 2 hours or the like)) and, after processing the script, transmits test messages (with test orders/instructions) to a subset of the game platforms. The test messages are configured based on a client-side communications library providing communication protocols for the communications hub module, the communications hub module receives the test messages and generates game platform test messages from the received messages based on communication libraries for the game platforms.

The testing is external, and the testing framework receives test data, corresponding to performance of the test functions of the selected test script, from one of the game platforms via the communication hub. Then, the testing framework verifies completion of one or more of the test functions by processing the received test data. In addition to bi-directional communications, the selected script may include a conditional having a parameter provided in the received test data, and the testing framework may issue an additional test message in response to the parameter satisfying the conditional. For example, the additional test message may include an instruction/order requesting additional test data from one of the game platforms (e.g., when FPS metric/parameter is less than 30 FPS, retrieve full CPU usage and a memory report or the like).

In some embodiments, each of the game platforms may include a test communication module (or “automation manager” as a relatively thin layer on the video game) that communicatively links the video game with the testing framework. Further, in some embodiments, the subset of the game platforms receiving the test messages may include at least two of the game platforms that function to concurrently perform one or more of the test functions and report test data based on the test function performing to the testing framework. In such cases, the game platforms may have differing hardware or software configurations, and the test messages may cause like ones of the test functions to be performed on the game platforms, whereby an automated test is repeated within the testing farm. For example, an Xbox® console and a Playstation® console running copies of the same game may be instructed to both perform a test or test function (e.g., concurrently used to reboot the game and load a level or character or the like). In other examples, though, the game platforms may have matching hardware and software configurations, and the test messages received by the at least two game platforms may cause differing ones of the test functions to be concurrently performed, whereby an automated test is distributed over the testing farm. For example, a subset of Xbox® consoles (e.g., 4 game consoles) may be used to run differing portions of a test to complete the test in a fraction of the time (e.g., one fourth the time if only one game platform were used).

### BRIEF DESCRIPTION OF THE DRAWINGS

FIG. 1 is a functional block diagram of a video game development system or network configured according to prior communication methods;

FIG. 2 illustrates a functional block diagram in contrast to the system of FIG. 1 shows a video game development system or network adapted according to an embodiment of the invention with a developer communications hub facilitating communications between game development tools and games running on differing video game platforms and, optionally between the tools themselves;

FIG. 3 illustrates a functional block diagram of video game development system or network providing additional detail of an exemplary implementation or embodiment illustrating that games use a client-side communication library (that may be built into each tool) to create or use a single communication socket to transmit and receive game data or development messages from the central hub application;

FIG. 4 illustrates a development system or network illustrating in more detail one exemplary computer system useful for implementing the communication methods, authoring methods, testing methods, and other functionality described herein;

FIG. 5 is flow chart illustrating generally a game development or hub-based communication method of an embodiment of the invention;

FIG. 6 is a functional block diagram of an automated game testing system or network according to an embodiment of the invention showing use of a testing framework or software suite along with a communications hub application to facilitate test-hosting PC-to-game platform communications and to support automated and remote (or off console) testing of video game software;

FIG. 7 is a schematic illustration of a portion of testing system or network illustrating bi-directional communications between a testing framework on a host-testing device and a platform or console running video game software during a test of the game software;

FIG. 8 is a flow chart illustrating steps or processes carried out in an exemplary automated testing method such as may be carried out by operation of the testing system of FIGS. 6 and 7; and

FIG. 9 is a flow chart showing the processes of an exemplary conditional or reactive game testing method using bi-directional communications to perform a software test of game software under development from an external or remote test-hosting computer system.

### DETAILED DESCRIPTION OF THE PREFERRED EMBODIMENTS

Briefly, embodiments discussed in the following description are directed to methods and systems that automate the testing of a video game using multiple game platforms (a “testing farm”). The game platforms may be similar in configuration (e.g., all be Xbox® consoles) or may differ in configuration (e.g., some may be Xbox® consoles while others are Playstation® consoles), and the same test may be performed on all the platforms (e.g., all platforms used in running a test that involves loading Levels 1 to 3 or the like) or the test may be distributed (e.g., a first set of platforms is used for a first test that involves loading Levels 1-3 while a second set of platforms is used for a second test that involves loading Levels 4-6 so as to cut the test time in half or otherwise distribute the testing load).

In designing a new test system and method, the inventors were trying to create a testing solution that is cost effective and that better adheres with proper testing philosophy, e.g., does not significantly burden the processor(s), memory, or other hardware of the platform or otherwise interfere with a running game. In some embodiments, the testing system provides a testing framework that may be run on a test-hosting device (e.g., a host PC or the like), and this testing framework may include a set of test scripts that a test engineer may select and run on a selected set of platforms in a testing farm. The test scripts can be written once and then interpreted by the testing framework to test against any of the available game platforms in the testing firm regardless of the particular configuration of the platform (e.g., regardless of its manufacturer and its particular communications library). The test-hosting device communicates with any number of game platforms (which may involve concurrent communications being transmitted and/or received by the test-hosting device via a communications hub, which is described in detail below and which links the platforms in the testing farm with the test-hosting device and the testing framework.

During operation of a representative test system, verification of whether a test succeeds or fails is provided based on bi-directional communication between the test-hosting device (e.g., the testing framework) and the array or set of game platforms being used in the particular video game test. The test-hosting device or PC uses one or more software modules (or “systems”) within its testing framework to interpret a test script, which can be used for any of the game platforms, and transmits orders to each platform instructing it to perform actions as part of the test (e.g., load a game, load a level, capture and report FPS, and so on). Each of the video game platforms then performs each of their tasks defined in the transmitted orders and then sends test data/information back to the testing framework on the test-hosting PC including whether there were any failures (e.g., the game failed to load, a particular level failed to load, and so on). The testing framework receives this test data/information and processes it to decide if the test should continue or, in some cases, whether subsequent testing on one or more of the platforms is not required (e.g., a waste of time based on failure data or the like).

Significantly, the tests and instructions/orders to the game platforms to carry out game-testing actions originate with the testing framework on the test-hosting device or PC. As a result, the “tester” is separated from the “testee” in a more controlled environment. This control allows for fatal errors on the side of one or more of the game platforms to occur without test data being lost or the test failing midstream. If a video game platform experiences a fatal error while performing a test function or step, the testing framework on the test-hosting PC is alerted to a loss of communication with the failed platform, and the test is tallied as a failure. The testing framework may then act to power the failed game platform off and on again to continue running more tests/test functions (or in other common cases, there may simply be a re-launching of the game software otherwise called a “soft reboot” or a “title reset” referring to the game title software), and the test-hosting PC as the “tester” is not impacted by the fatal error as was typical in embedded tests running on the game platform. However, in most scenarios, communication is not lost with a failed platform, and a crash or exception is “caught” by the game platform, the game platform sends information back to test-hosting PC, which is not human readable. The test-hosting PC with its software may translate this into a form that is human-readable (a “call stack”) so that programmers may determine the nature and cause of the crash or exception.

As will become clear from the following description, the automated testing methods and systems allow for the test-hosting device or computer running the testing framework (and its software applications/modules/systems) to perform most or a majority of the work required to determine how to test a game and then observe/monitor and process the test data or results in a controlled environment without such processing impacting the result or outcome of the test. In addition, a large benefit of the testing system is that all testing across any number of game platforms can be conducted concurrently. In the past, tests were run on and against a particular game platform and, when those tests were completed, the tests were run on a next game platform. The testing system saves time and provides more rapid feedback to the game developers about stability because the test systems can run multiple tests across multiple video game platforms that running a game that is under development.

In part, the testing methods and systems are made possible through the use of hub-based communications (e.g., use of a communication hub application between the testing framework and the game platforms). With this in mind, the hub application will be described first before turning to an exemplary testing system and automated testing methods according to aspects of this description. For example, the communications hub application may be implemented using the techniques described in U.S. patent application Ser. No. 12/328,619, entitled “Communication Hub for Video Game Development Systems,” which is co-owned, which was published Jun. 6, 2010 as U.S. Pat. Appl. Publ. No. 2010/0144443, and which is incorporated herein in its entirety by reference.

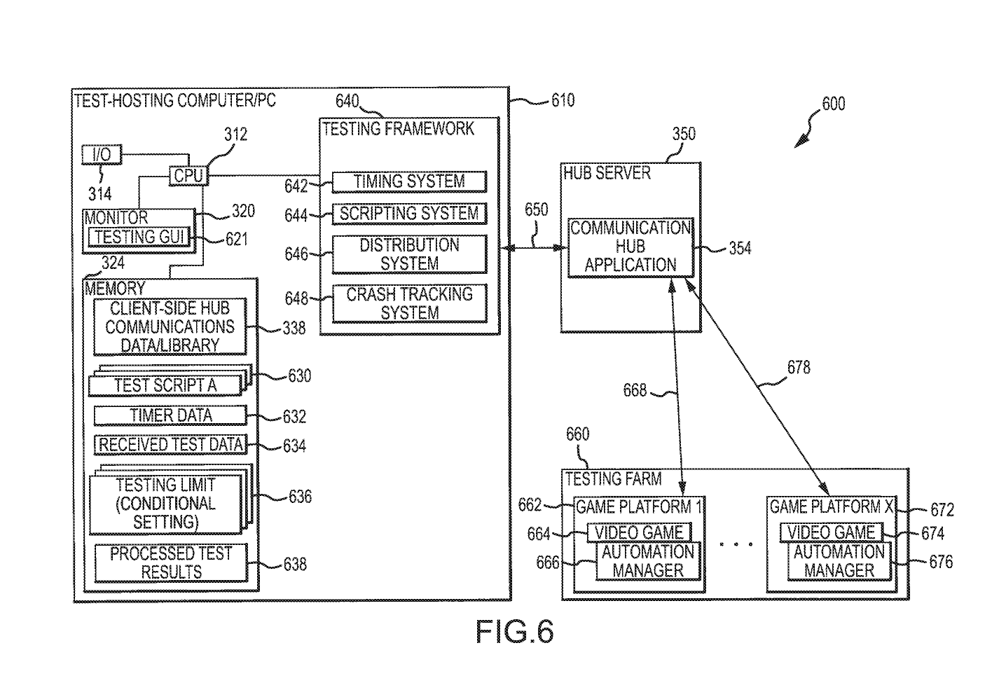

Briefly, the communications huh may provide a method for managing communications within a video game development system or network, which may be configured for automated testing. With the communications hub, a game development system or network may be provided that lessens the processing overhead, usage complexity, and maintenance requirements for each game development tool used by a game developer by providing a central hub communication application in the development system or network that establishes a communication interface(s) between each tool and differing game platforms. Likewise, such a communication interface(s) may be provided between a testing framework and a testing farm with a number of game platforms as is discussed beginning with FIG. 6. The hub communication application (or the server running such an application) acts as a message passing hub that extracts (or determines) the recipients (which game platform is to run a particular test or perform a particular testing function) for a message issued by a development tool or testing framework (or software system within such a framework) and transmits the content (e.g., game data such as modified game logic to be used by a game engine on a platform, a game asset such as a new character or object in 3D model or other form, and/or a game parameter such as lighting level, texturing, testing orders/instructions, and the like) as-is or with reformatting to the recipients in the game development system or network.

As background, the following description provides examples of particular computers, computing devices, workstations, video game platforms/consoles, communication networking and digital connections, memory devices, and other computing hardware and software resources used in video game development. However, it will be understood that these are only representative examples of useful implementations of the invention and not as limitations to its breadth. Further, embodiments of the invention may be thought of generally as a computer-based method for supporting communications, authoring, and testing during game development (e.g., while operating a developer terminal, node, PC, workstation, or the like and using one or more video game development tool), the particular software, firmware, and/or hardware used to implement the described methods and functions are also not limiting of the invention. In general, the algorithms, routines, and processes described herein may be implemented upon nearly any computer-readable medium that can cause a computer or computer system to perform a corresponding function.

For example, the hub communication application and testing framework may be provided as software or programming code for causing a computing device such as a developer's computing device or a central/networked server to perform particular functions as part of creating a game development computing and communication environment and may be stored on a memory device of nearly any node accessible via wired or wireless connections by video game development tools and run on a device that uses one or more processors or CPUs to run the software. The video game development workstations and test-hosting workstations/devices/PCs likely will include a number of input/output devices I/O devices) such as a keyboard, a mouse or trackball or the like, a touchscreen or pad, a voice recognition mechanism, and the like. A monitor or monitors will also be provided to allow the user to view one or more user interface (such as windows created as part of the computing environment to view and/or access video game tool interfaces and view/modify game data such as game logic, game settings, game assets, game parameters, and the like). Such user interfaces may be nearly any combination of menus, screen designs, keyboard commands, command language, and the like (including in some cases mice, touch screens, and other input hardware such as voice recognition) to allow a user to interact with a computer and with video game digital assets and data stored in memory in a particular computing environment. The invention may also be implemented using one or more data servers that may communicate with the workstations over a digital communications network such as the Internet, a local area network, a wide area network, or the like using any of a number of well-known or later developed communications protocols (wired or wireless), and the browsers and related applications may be provided as web applications accessible in particular computing environments.

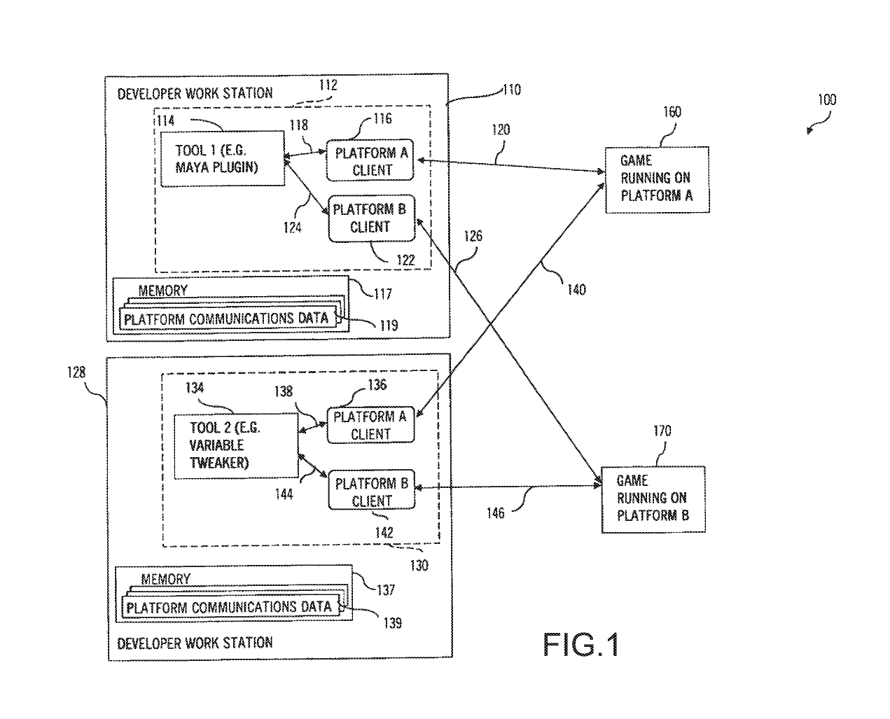

To assist in understanding some of the benefits of such a hub-based communication system and method as part of the game development and testing process, it may be useful to discuss an existing or more conventional game development system 100 as shown in FIG. 1. In a conventional game development system 100, a number of developers may use workstations 110, 128 to present a computing or working environment 112, 130 in which one or more development tools 114, 134 (such as the Maya Plugin, a Variable Tweaker tool, a logic update tool, and the like) are run so as to develop a video game. This game may be run on a number of differing video game platforms or consoles as shown as platform A and platform B with the running games shown as boxes 160, 170. The computing environment 112, 130 of each workstation 110, 128, may include memory or data storage 117, 137 that is used to store a communication/interface library or platform communications data 119, 139. Such communications data may define all or some subset of the messaging formats and transmittal protocols expected by each video game platform, and, typically, each of the sets of platform communications data 119, 139 defines an at least partially different set of rules that must be followed for the tools 114, 134 to communicate properly with the running games 160, 170 on the platforms. If a developer were working with just one platform, this may not be too much of an issue, but, more often, each development workstation 110, 128 and running tools 114, 134 are used to develop a game 160, 170 for use on two, three, or more video game platforms. Hence, it is important for the tools 114, 134 to be able to communicate with each platform or game running 160, 170 on such varying platforms (such as those developed and distributed by Sony, Microsoft, Nintendo, and other gaming platform manufacturers).

Presently, development tools 114, 134 used in the video game industry typically provide no communications or, if they do provide a form of communication, function as shown by using a one-to-one connection 120, 126, 140, 146 between the tool 114, 134 and the running games/platforms 160, 170. To establish communications, the tools 114, 134 may be thought of as creating communication clients 116, 122, 136, 142 for each game 160, 170 that they wish to communicate with during development/operation of system 100. Further, such one-to-one communications may be thought of as requiring the tools 114, 134 to each create and manage communication sockets 118, 124, 138, 144 to allow direct messaging 120, 126, 140, 146 to and from the running games 160, 170. In the system 100, each tool needs to understand how to communicate with each platform 160, 170 separately. For example, a communication link along with messages formatted as required by the communication data 119 for a particular platform 160 likely cannot be used for sending a message with the same content to the other platform 170. In a more concrete example, a certain tool 114 or 134 may use one set of communication data 119, 139 (e.g., information/data provided in a video game platform developer's SDK or the like) to update objects or other game assets/data on a Sony PS3® platform (or first platform) but could not use these same communication techniques/methods to send messages updating the same objects or other game assets/data on a Microsoft Xbox® 360 (or second platform). Further, the one-to-one communication technique has not been useful in allowing tools to communicate between each other or with other tools as the tools 114, 134 generally would need to have explicit knowledge of the other running tools in order to establish a connection.

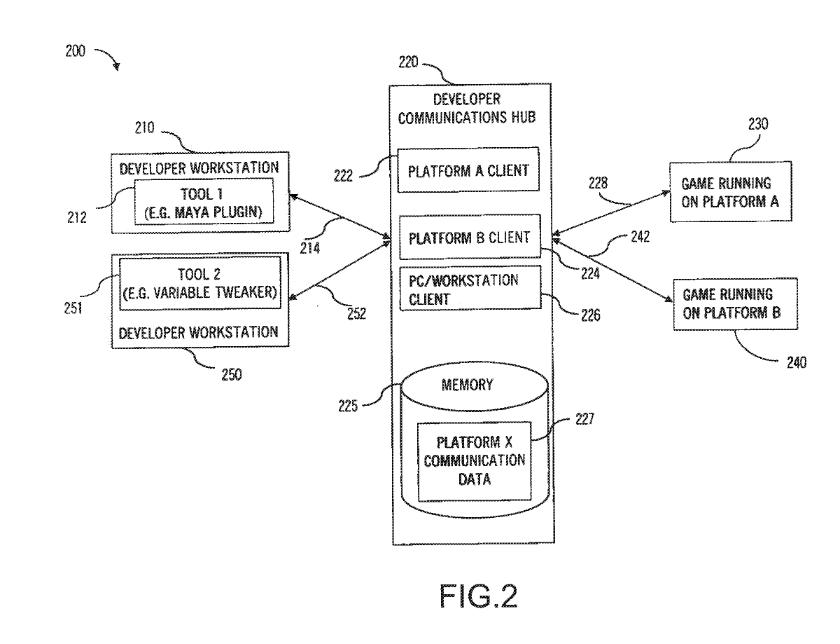

In contrast, FIG. 2 illustrates a game development system or network 200 that is adapted such that the individual games do not have to have knowledge of the particular platform communications data and/or rules or even what games and/or tools are “listening” or connected to the game network 200. The system 200 again includes a pair of developer workstations 210, 250 that are running video game development tools 212, 251, but only a single connection 214, 252 is maintained/used by each tool 212, 251 to communicate with both games 230, 240 running on two differing platforms and, optionally, with other tools (which is not typically done within the system 100 of FIG. 1).

The system 200 simplifies game development communications by including a developer communications hub 220 (e.g., a server or other computing device that may take the “server” role for messaging within system 200). The hub 220 runs a central hub communications or message-passing application that abstracts the knowledge of platforms and existence of other tools from the individual tools 212, 251, and such a centralization and abstraction of communications duties allows the tools 212, 251 to communicate with each other and with any game platform 230, 240 without requiring specific knowledge of the intended recipient and potential interfacing, message formatting, and other communication requirements imposed by that recipient. The system 200 does this generally by centralizing the knowledge of how to connect with different platforms 230, 240 into a central hub application and, in some cases, by building a client side communications library into each tool (not shown but used to allow the tools 212, 251 to communicate with the hub application with a relatively simple messaging protocol that can be used for all of its messaging and data transfer in system 200). Such a library may also be used to allow the platforms 230, 240 to connect with the hub 220 (or hub communication application running thereon).

As shown, the hub 220 provides an interface to a client 222 for tools 212, 251 to communicate with games running on a first platform 230 (shown as Platform A) as well as communication clients 224, 226 for tools 212, 251 to communicate with games running on a second platform 240 (shown as Platform B in FIG. 2). The hub 220 includes memory or data storage 225 for storing communications data or libraries 227 (such as those provided in video game SDKs and the like) for each of the platforms 230, 240. The information is used by the hub application running on hub 220 to provide the interfaces between the tools 212, 251 that send the hub-formatted messages over links 214, 252 and games 230, 240 running on differing platforms and linked to hub 220 via links 228, 242. The communications may be managed, in part, by the hub application creating communications clients 222, 224, 226 based on the platform communications data 227 in memory 225.

During operation of system 200, a tool 212 or 251 transmits a message over link 214 or 252 (such as a message to modify a lighting setting or a texturing of an object of the game or so on) that is formatted per the client-side hub library (not shown in FIG. 2). The hub 220 acts to determine which recipients should receive the message content such as one or both of the games on the two platforms 230, 240 and tool 212 or 251. The hub 220 then uses the appropriate communications data/libraries 227 to reformat/translate the message for each recipient (and/or uses the created clients 222, 224, 226 to manage such communications and comply with communication rules). The hub 220 then forwards the message to the interested or determined set of recipients in the system 200. As can be seen from the relatively general illustration of system 200, the tools 212, 251 and games 230, 240 need only know how to talk or communicate with the hub 220, and there is no need for specific knowledge of the communication rules of the intended recipient(s) to send game information or data out onto the network or system 200 and to the recipient(s). In contrast to the system 100 of FIG. 1, the tools 212, 251 do not need to manage communication clients and/or sockets for each possible platform or store/access communications data/libraries for each game platform. Further, the system 200 allows the tools 212, 251 to communicate with each other (as is explained in more detail below).

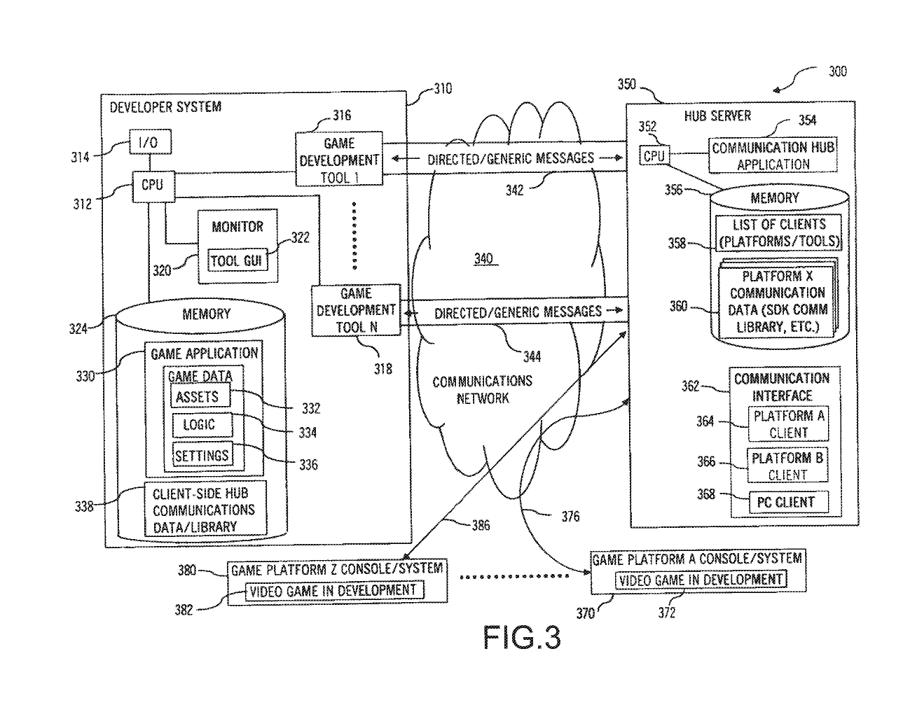

FIG. 3 illustrates in more detail a video game development system 300 that may be used to implement the communication methods of an embodiment of the invention. In this embodiment, a developer computing system 310 is shown that includes a CPU 312 running two or more video game development tools 316, 318 such as those used to create 3D models, to set or adjust game logic, to create objects, characters, or other game assets, and so on. I/O devices 314 may be provided to allow a developer to interact with the tools 316, 318 and game data, and one or more monitors 320 are included to view tool GUIs 322 and otherwise view/interact with tools 316, 318 and game data. The system 310 further includes memory 324 that stores client-side hub communications data/library 338, and this includes data to enable the tools 316, 318 to communicate with the communication hub application 354 (and through this application 354 with games under development 372, 382 or other ones of the tools 316, 318 (or tools on other systems 310 not shown)). The memory 324 is also shown to include a game application 320 such as a game being developed or a recent build of such a game (or this data may be stored on another memory device accessible by system 310 and other developer systems). The game application 330 includes game data such as game assets 332, game logic 334, and game settings 336, and the game application 330 can be thought of as being defined by this game data; hence, game development includes using the tools 316, 318 to create and modify the game data in memory 324 and/or on a miming game 372, 382 on a number of video game platforms/consoles 370, 380.

The system 300 also includes a communications network 340 that is used to connect the developer system 310 with a hub server 350. The hub server 350 includes a CPU 352 that runs a communications hub application 354. The CPU 352 also manages memory 356 that is shown to store a list of clients (e.g., platforms, tools, games or subsystems of games registered with the hub application, and the like) for receiving system communications. The memory 356 also stores platform communication data (e.g., SDK communication libraries for each platform 370, 380) for each platform 370, 380 in the system 300 or expected to be added to/used within system 300. The hub server 350 runs the communication hub application 354, and the application 354 may function to provide a communication interface 362 between the tools 316, 318 and the game platforms 370, 380 (and between tools 316, 318 themselves). To this end, a communication client 364, 366, 368 may be created by the hub application 354 using the platform communication data sets 360 for each platform 370, 380 as well as rules/protocols for communicating with the workstation/system 310.

During operation of the system 300, each of the game development tools 316, 318 may use the client-side hub library 338 as a built-in or runtime communication mechanism to create and manage a hub communication socket or link 342, 344 via network 340 to send messages to and from the hub application 354 on server 350. These messages may include game data such as modifying game logic 334 or an asset 332 on games 372, 382 (e.g., the same game running on two differing platforms). The hub application 354 processes these messages via interface 362 and clients 364, 366, 368 and/or communication data 360 to determine the recipients for the message, to place the message in the expected format for those recipients, and to transmit the message over links 376, 386, 342, 344 as appropriate. The list of clients 358 may include the video games 372, 382 or one of the tools 318 and each message may be sent to one, a set of, or all of such recipients depending on the content (who is registered as being interested in that type of content/message) and/or on a recipient list/addressee in the message from the tool 316, 318 (such as to a particular game or game subsystem or to any tools interested in a particular game data).

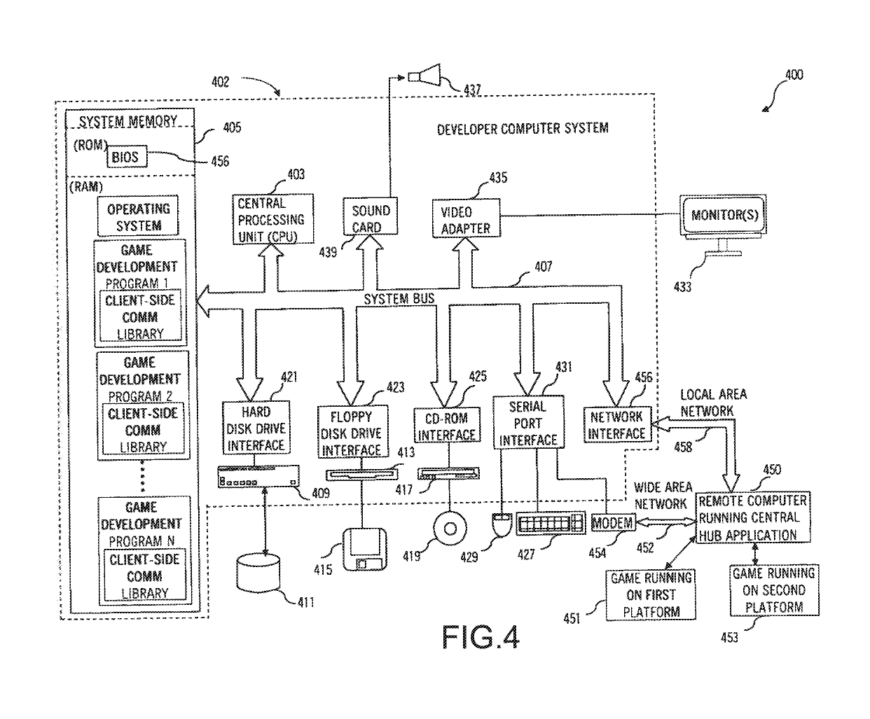

FIG. 4 generally illustrates a game development system or network 400 that may be used to implement the hub or centralize communication techniques and other functions/processes described herein including the automated testing functions using a testing framework to communicate via a central communication hub application. The network 400 includes a computer system 402, which typically is used by a game developer (or member of a video game development team) and includes a processing unit or CPU 203 and system memory 205 with one or more game development tools that may be run by CPU 203. As discussed above, each of the game development tools or programs may have a built-in client-side communications library that provides the information required for the program to communicate with a central communication hub application running on a remote computer 250 (or on one of the developer computer systems 402 in a distributed system/network), and, in this manner, messages generated by the game development programs can be relatively simple and/or generic in form and be delivered via the central communication hub application to games running on first and second (or more) platforms 451, 453 that may have differing communication requirements (e.g., differing message configuration/content, differing transmission protocols, differing communication and/or client interfaces, and the like such as may be specified by each platform developer's SDK or a communication library in the SDK or otherwise specified).

A system bus 407 couples various system components including system memory 405 to processing unit 403. System bus 407 may be any of several types of bus structures including a memory bus or memory controller, a peripheral bus, and a local bus using any of a variety of bus architectures. System memory 405 includes read only memory (ROM) and random access memory (RAM). A basic input/output system (BIOS) 456, containing the basic routines that help to transfer information between elements within computer system 402, such as during start-up, is stored in ROM 456. Computer system 402 further includes various drives and associated computer-readable media. A hard disk drive 409 reads from and writes to a (typically fixed) magnetic hard disk 411; a magnetic disk drive 413 reads from and writes to a removable “floppy” or other magnetic disk 415; and an optical disk drive 417 reads from and, in some configurations, writes to a removable optical disk 419 such as a CD ROM or other optical media, and, of course, other removable memory devices may be inserted into and accessed (read and/or writing of data) via a port such as a USB or other communication port in a housing of the system 402. Hard disk drive 409, magnetic disk drive 413, and optical disk drive 417 are connected to system bus 407 by a hard disk drive interface 421, a magnetic disk drive interface 423, and an optical drive interface 425, respectively. The drives and their associated computer-readable media provide nonvolatile storage of computer-readable instructions, programs, procedures, routines, data structures, program modules, and other data for computer system 402 (such as initial installation of the client-side communications library and/or for backup storage/transfer of game application or game assets). In other configurations, other types of computer-readable media that can store data that is accessible by a computer (e.g., magnetic cassettes, flash memory cards, digital video disks, random access memories (RAMs), read only memories (ROMs) and the like) may also be used.

A number of program modules such as game development tools, testing routines, and the like may be stored on hard disk 411, removable magnetic disk 415, optical disk 419 and/or ROM and/or RAM of system memory 405. Such program modules may include an operating system providing graphics and sound APIs, one or more application programs, and a testing framework with software systems/program modules or subroutines, and test results and output of processing such test data. A user such as a software tester or developer may enter commands and information into computer system 402 through input devices such as a keyboard 427 and a pointing device or mouse 429. Other input devices may include a microphone, a joystick, a game controller, wireless communication devices, a scanner, or the like. These and other input devices are often connected to processing unit 403 through a serial port interface 431 that is coupled to system bus 407 but may be connected by other interfaces, such as a parallel port interface or a universal serial bus (USB) or by wireless connections. A monitor(s) 433 or other type of display device is also connected to system bus 407 via an interface, such as a video adapter 435, for viewing game development and game testing GUIs (e.g., that may be used for selecting test scripts to initiate automated tests) or other game data.

Computer system 402 may also include a modem 454 or other means for establishing communications over network 452, such as the Internet, a LAN, a WAN, or the like. Modem 454, which may be internal or external, is connected to system bus 407 via serial port interface 431 (or some other interface). A network interface 456 may also be provided for allowing computer system 402 to communicate (e.g., establish communication sockets and the like) with a remote computing device or server 450 via a local area network 458 (or such communication may be via wide area network 452 or other communications path such as dial-up or other communications means). Computer system 402 typically includes other peripheral output devices, such as printers and other standard devices (not shown). Computer system 402 is preferably equipped with an operating system supporting Internet communication protocols and/or other digital communications network protocols and communication interfaces (e.g., to support digital communications with the central communications hub on computer 250 via messages generated and transmitted based on the definitions/requirements of the client-side communication library typically built into the game development programs). Other types of computer systems other than or in addition to the one shown are usable to practice the invention (e.g., a local area network of computers, an interactive television, a personal digital assistant, an interactive wireless communications device, electronic devices with adequate computing capabilities and memory, or the like).

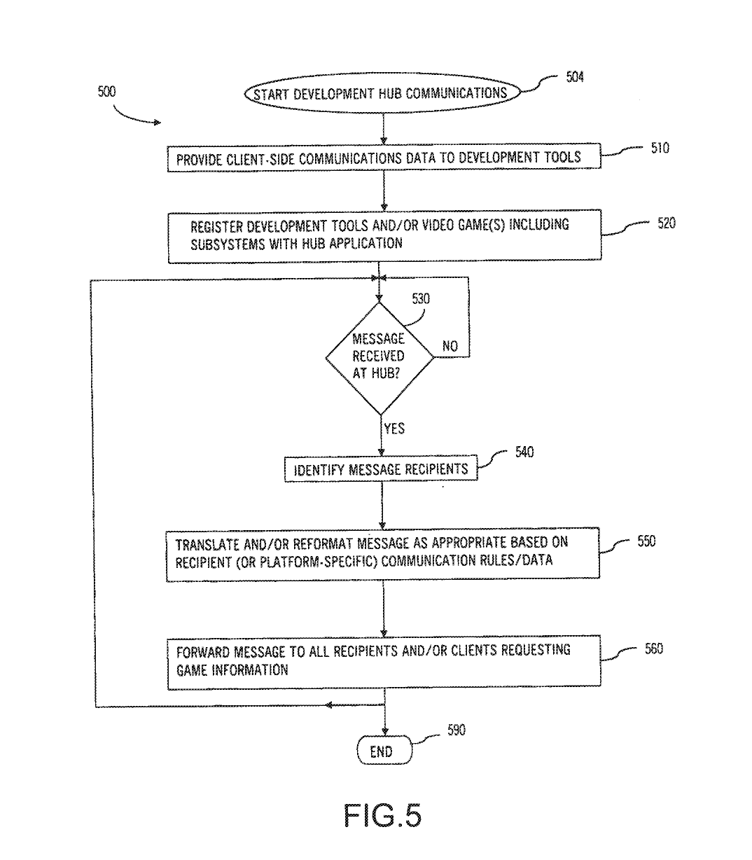

FIG. 5 illustrates a video game development communications method 500, as may be implemented by the systems 200, 300, 400 of FIGS. 2-4. At 504, the method 500 starts by loading or providing a central hub application within a video game development system or network. The communications data or libraries for each game platform or console that is being used or may later be connected to the network may be made available to the central hub application. At 510, the method 500 continues with providing client-side communications data or a hub library to each of the development tools or to the workstations that run such tools, and, as discussed below, the tools may include the testing framework. The client side library may be a runtime library stored in the workstation memory. The client-side libraries include the data or information (such as messaging configuration/format and/or other communications protocols) to allow the tools to communicate with the central hub application.

At 520, the method 500 continues with registering development tools (including the testing framework shown in FIG. 6 used for automating the testing of game software on game consoles/platforms of a testing farm) and/or video game(s) with the hub application to create a recipient list for the development network or system. Tools may register to be informed when particular game data is altered, testing framework may register to be informed about test results, and the video games typically are registered in a subsystem manner to receiving communications/messages from tools including modified game data (e.g., a materials subsystem, an objects subsystem(s), a texturing subsystem, a lighting subsystem, systems or subsystems of a testing framework, and so on may each register with the hub application for a particular video game running upon a game platform linked to the development system or network). This aspect of the system allows tools and the testing framework to direct messages to a particular subsystem instead of relying on the game to determine the appropriate subsystem itself.

The method 500 then may include the hub application monitoring the communication network for a next message to be transmitted from a tool or game. When a message is received at the hub, the method 500 continues with the hub application acting to identify message recipients at 540. For example, in some embodiments, the tools may transmit messages in a generic manner with no addressees specified, and in such cases the message may be sent to all recipients on the hub recipient list or a subset interested in a particular type of message or message content. In other cases, the message may be transmitted by the tool in a form that specifies one or more (a set) of recipients for the message, e.g., a message to a game running on one platform or another tool.

At 550, the hub application translates and/or reformats the message as appropriate based on the identified recipients and the communications data (rules, libraries, and the like) associated with each of these identified recipients. For example, a hub-formatted message from a tool may be reformatted or translated to comply with communications data/rules for a first game platform and also for a second game platform. Then, at 560, the method 500 continues with the hub application forwarding the message to all identified recipients or to clients requesting the game information in the message. In some cases, the hub application handles opening communication links or sockets for each platform (and/or for each recipient or the like). The method 500 may continue at 530 with waiting for additional game development or related messages (or more testing instructions, testing data from a game platform, or the like) or end at 590. Generally, the method 500 may be used for one-to-one communications as a tool or other sender of the development network may specify the recipient or addressee, but the method 500 also supports a one-to-many connection or broadcasting communication methods as a tool can make a change to a particular game data (such as tweak a portion of the game logic) and transmit a generic hub-format message that will be sent by the hub application to all interested recipients (e.g., to all games or game subsystems affected by the change). As a result, a developer does not have to create and send a message for each platform to have the change implemented by running games. Likewise, a tester can write a script once and have that the script's test messages/instructions properly communicated to a number of game platforms in a testing farm such that the scripts may be written in a relatively generic form (rather than specific for each platform to allow embedding within the game itself).

FIG. 6 is a functional block diagram of an automated game testing system or network 600 according to an embodiment showing use of a testing framework or software suite along with a communications hub application to facilitate test-hosting PC-to-game platform communications and to support automated and remote (or off console) testing of video game software. The testing system 600 includes a number of components similar to those discussed in detail with the system 300 of FIG. 3 with like numbers being used for those components and the description of FIG. 3 is applicable to FIG. 6. For example, the system 600 includes a hub server 350 running a communications hub application 354 that functions to receive over link 650 messages (e.g., game testing instructions/orders) from a testing framework 640 running on test-hosting computer 610. These messages on link 650 are formatted according to a client-side hub communications data/library 638 (which may be a built-in library for framework 640 or accessed in memory 324 of test-hosting computer 610). The hub application 354 may act to process the test instruction messages to determine a set recipients specified in the message (e.g., as defined by distribution system 646) or, in some cases, from content of the messages on link 650. The received messages transmitted to hub server 350 over link 650 by testing framework 640 are then reformatted/translated for each recipient (e.g., one or more of the game platforms 662, 672) based on communications data for that recipient (e.g., what format does platform 662 or 672 expect/require as discussed above) and forwarded to those recipients via a network or a direct connection.

Likewise, the developer computer system 610 is similar to system 310 in that it includes a CPU 312, I/O devices 314, and a monitor 320 for displaying information including testing data in tool GUI 621. The system 610 also uses the CPU 312 to run a testing framework 316 (e.g., a set or suite of software applications such as modules useful for performing the automated testing of the present invention). The GUI 621 may be useful for displaying availability and status of game platforms 662, 672 (e.g., each platform/console may be shown with its configuration (e.g., Playstation Xbox®, Nintendo GameCube® and version), its present test state (e.g., running test function/step “X”), and/or the like), and the GUI 621 may also present a tester using the host PC 610 access to test scripts 630 to allow the tester to choose one or more test scripts 630 to run on testing farm 660 (as discussed more below) and, in some cases, which platforms 662, 672 to run the test defined by the script 630 upon (or this may be handled by distribution system 646). In system 600, the testing framework 640 is able to link to and communicate with the communications hub application 354 using a client side library 338 that defines how to interface and communicate with the hub application 354 including how to format testing messages (instructions/orders/queries defined by test scripts 630).

As shown, the testing framework 640 may include a number of subroutines or software-implemented systems that it utilizes to perform automating testing of game software. For example, the testing framework 640 may automatically test video game software 664, 674 run on game platforms 662, 672 in testing farm 660, which is in communication with hub server 350 via links 668, 678. As shown, the testing framework 640 includes a timing system 642 that functions to track the timing of transmission of testing instructions and to time the length of testing steps. The timer data 632 may be stored at least temporarily in memory 632 for later processing, e.g., for use in graphing performance of a game platform 662, 672 over time as part of processed test results 638 that may be displayed in GUI 621 or otherwise reported to a tester using host PC 610. For example, the testing framework 640 may use a script 630 to initiate a test of video game 664 on platform 662, and the time the test is initiated may be used by the timing system 642 to determine a length of time in performing one or more steps/functions of the test and identify, in some cases, a timeout condition in which the test should be cancelled and tallied as a failure (e.g., a game may fail to properly load in a preset amount of time, a level may not be loaded within a predefined time period, and so on, which may indicate failure of the test as identified by timing system 642).

Memory 324 is shown to store one or more test scripts 630 that may each define a test to be run within the testing farm 660 to stability or otherwise test video game software 664, 674. The test scripts 630 may be generated by a tester via testing GUI 621 or written elsewhere and stored in memory 324 (e.g., loaded over a network from other computers (not shown)). The test scripts 630 may be written once and interpreted by the testing framework 640 to test against any of the game platforms 662, 672. The testing framework 640 also includes a scripting system 644 that may perform this interpretation function to process the scripts 630 and issue test instructions in messages on link 650 to hub server 350, which uses hub application 354 to reformat the test messages and send them via links 668, 678 to game platforms 662, 672. For example, a test script 630 may be written to call for one or more consoles 662, 672 to reboot a game 664, 674, and the scripting system 644 may process the script (which may be written relatively generically as formatting for platforms 662, 672 is not required) and transmit the instructions required to cause the consoles 662, 672 to try to reboot games 664, 674 via hub server 350. The scripting system 644 may also present the available scripts 630 to a user of host PC 610 in GUI 621, and the user/tester may select which scripts 630 to run to test software in an automated manner.

Significantly, the testing framework 640 is run on the test-hosting computer 610 rather than being embedded in the video game software 664, 674. However, an automation manager or module 666, 676 typically is provided on each platform 662, 672 to facilitate communicates with the testing framework 640 and to implement testing instructions and return test data to test-hosting computer 610 (shown as received test data 634 in memory 324). The automation manager 666, 676 may be implemented as a thin layer associated with the game software 664, 674 that provides hook ups or mapping to game code to carry out test instructions (e.g., to load a new/additional character or object into a game) and to perform exception handling. The automation manager 666, 676 generally is adapted to send test data 634 via hub 350 to testing framework 640 as the data is observed/collected (e.g., the data is typically not stored in memory of the game platform 662, 672).

For example, one significant advantage of the testing system 600 is that automation manager 666, 676 acts to send crash data/crash stack upon its occurrence whereas past embedded testing techniques typically required manual processing of the platform memory to try to obtain this information. The automation managers 666, 676 require a small or minimal amount of memory and processing capacity of the platforms 662, 672 such that the testing environment is not polluted when a test script 630 is used to run/perform a test by the testing framework 640. The testing framework 640 may include a crash tracking system 648 to process the received crash stack from the automation manager 666, 676 to generate processed test results 638. For example, the crash tracking system 648 may determine that a game 674 crashed when the game platform 672 attempted to load a particular level and report this to a developer (e.g., a developer may have created/modified a level of a game 664, 674). The same test may have been run on platform 662 without a crash resulting and such results may also be reported to the developer by crash tracking system 648 as part of processed test results 638 (e.g., platform 662 may be one type of console while platform 672 may be a differing type of console such that this test indicated that the level can be properly loaded on one type of platform but not on another type).

The testing framework 640 further includes a distribution or automation system 646 that functions in some cases to determine which platforms 662, 672 are to be used in a test. In some cases, a tester may be able to select sets of the platforms 662, 672 to run a test defined by a test script 630. In other cases, though, the tester may not be concerned with such control over the test. Hence, the distribution system 646 may be adapted to choose subsets of the testing farm 660 for running a full test or portions of a test defined by a script 630. For example, the distribution system 646 may, prior to initiating a test, query the testing farm 660 via the hub server 350 to determine the availability and status of the game platforms 662, 672. With this information (e.g., numbers of platforms of particular types available for use in a test), the distribution system 646 acts to transmit all or portions of the test instructions to a recipient list in the testing farm 660.

For example, the distribution system 646 may distribute a test load to complete it as quickly and efficiently as practical. This may involve splitting or dividing up the test steps or work over the available platforms 662, 672 that are suited for running a test, e.g., need to test loading of 9 levels of a game and split this work into three sets of instructions when three platforms are available. In one testing example, each console 662, 672 may load three levels of a game 664, 674 so as to complete the work in one third of the time. In other tests, though, it may be desirable to repeat a test step/test run to verify stability of software. In such cases, all the available platforms 662, 672 may be used to run a test concurrently and report test results back over links 650, 668, 678 to the testing framework 640 as test data 634. In such cases, the platforms 662, 672 may be of the same configuration/type (e.g., all be Microsoft Xbox consoles or the like). In yet other tests, it may be desirable to concurrently run a single test on each different type of console/platform for which a game will be sold/used. In this case, the distribution system 646 may identify one or more platforms 662, 672 of each platform type and distribute the test instructions defined by a script 630 based on processing by scripting system 644 concurrently (or sequentially in some applications) to the platforms 662, 672 to perform the tests simultaneously (or at least partially so).

From the above discussion, it can be seen that the testing system 600 provides a number of advantages. The testing is nearly wholly external to the video game environment with the testing framework 640 run and testing data in memory 324 provided on a test-hosting computer 610 communicatively linked to the platforms 662, 672. The testing is distributed via distribution system 646, for example, in that steps or functions of a test may be spread over a plurality of platforms 662, 672, tests may be run concurrently to provide numerous runs of the same test, tests on differing platform types/configurations may be run simultaneously, and so on. Such distribution significantly increases testing efficiency to provide more timely feedback/results to game developers. Further, the testing framework 640 provided via scripts 630 is platform neutral. Particularly, the communication hub application 354 allows the test scripts 630 to be neutral with regard to particular platforms such that they can be run on all target platforms (e.g., the hub application 354 is able to communicate test instructions to all platforms 662, 672) regardless of the differences in hardware and/or software among the platforms 662, 672.

Further, the test scripts 630 act to provide an automation manager that is passive or latent in that they may be complex with two or more test steps or functions. The scripting system 644 may process a script 630 to identify a next test step/function, transmit these instructions to one of the game platforms 662, 672 (with the assistance of distribution system 646 in some cases), and then repeat until all test steps/functions are completed on this platform (e.g., reboot a game, load a level, load a character, capture a screen shot, and other steps that may need to be performed sequentially to get a game to a particular point of game play and associated code).

Another advantage in game software testing provided by system 600 is that it may be configured to be reactive to the received test data or to test results. For example, one or more of the test scripts 630 may include conditional instructions (“conditionals”) that when evaluated (e.g., by testing framework 640 based on received timer data 632, test data 634, or the like) causes additional steps/functions defined in the script 630 to be carried out as part of an automated test. The memory 324 may store testing limits or conditional parameters for this use. For example, a game developer may require that a game be rendered at 30 FPS and this value for a conditional (minimum frames per second) may be stored as a testing limit 636, and a script 630 may include a conditional to compare an existing/reported frames per second of a game platform 662, 672 with this testing limit 636. When the conditional is satisfied (e.g., frames per second is less than 30 FPS), one or more additional instructions/orders may be issued by the framework 640 to the particular game platform 662, 672 such as to generate a memory report, to capture a screen shot, to retrieve processor data, and so on. The conditionals may be nested, too, to allow additional troubleshooting steps or data collection to be performed (e.g., if upon a conditional being satisfied, check to see if another conditional is met or platform/game is in a particular operating state).

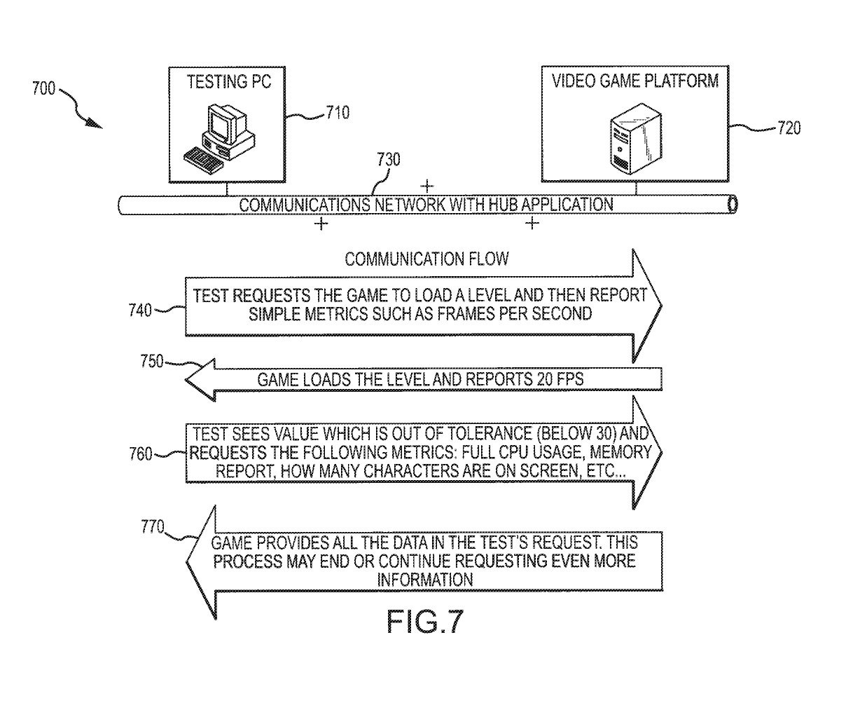

One of the powerful features of testing systems and methods described herein is that they make use of bi-directional communication between the testing framework and the game platforms. In this manner, a game platform, via automation manager or the like, may report during a test certain values that are out of tolerance (e.g., not within testing limits), and the “external observer” in the form of the testing framework may request additional information (e.g., drill down to obtain data useful in troubleshooting a programming bug such as an infinite loop or the like). FIG. 7 is a schematic illustration of a portion of testing system or network 700 illustrating bi-directional communications between a testing framework on a host-testing device 710 and a platform or console 720 running video game software during a test of the game software. The testing PC 710 and its testing framework may transmit platform-neutral testing instructions to a game platform 720 to perform a test/test step via a communications network/link that includes a communications hub application 730, which functions as described above to reformat the message to a form understood/expected by the game platform. Likewise, the communication hub in network 730 acts to received test data/communication messages from the video game/platform 720 that it reformats and transmits to the testing framework on test-hosting computer 710 for further processing.

FIG. 7 illustrates an exemplary bi-directional communication flow that may occur during an automated test run based on a test script in the testing system 700. The test script may be processed by a scripting system of the testing framework on testing PC 710. The testing framework on device 710 may communicate orders as shown at 740 via communications network and hub application 730 to the game platform 720 to perform a particular test step(s). As shown in the exemplary communication 740, the test may request the game on platform 720 to load a level and, if successfully loaded, to report simple metrics, such as frames per second, to the testing framework on testing PC 710. For example, one useful test of stability is to request a game to report back the frames per second metric periodically (e.g., once every few seconds) as this is a standard measure of performance for many video games.

In response, at 750, the game on platform 720 loads the level (without failure in this example) and reports back its present frames per second metric. In game development, it is common to establish a set of acceptable performance metrics or test limits, and it is common for a test limit/performance metric for frames per second to be greater than about 30 FPS. Hence, at 760 in operation of system 700, it is shown that the testing framework on test-hosting PC 710 determines that the received value for a metric (e.g., frames per second) is out of tolerance (e.g., below the predefined test limit of 30 FPS at 20 FPS).

Also, at 760, the testing framework is shown to respond to this determination by issuing a request to the video game on platform 720 for additional metrics (game or platform data). For example, the test script may include a conditional that causes the testing framework, when the FPS metric is less than 30 FPS, to request metrics useful in troubleshooting why a metric is outside of tolerance, e.g., for a low frames per metric, the testing framework may request the game provide full CPU usage (e.g., where the CPU time was being spent when FPS was low), a memory report (e.g., how much memory is available), characters on the screen, and the like. In other words, the “external observer” in the form of the testing framework requires more data in order to drill down further to get more information so that game developers/programmers can determine why the FPS dropped to its present unacceptably low level (or other metric has moved outside an acceptable range).

At 770, the video game on platform 720 collects and provides/reports all the requested additional data specified in the test instruction/request. The test framework on testing PC 710 may process this data to product test results to report to a tester/developer or may request additional information (e.g., perform further troubleshooting in an interactive and/or conditional manner such as if the memory report indicates that less than a certain amount of memory is available to obtain an additional metric value or the like). The communications shown in FIG. 7 between the testing framework (external observer) and the game being tested on the platform/console 720 allows thr extremely powerful tests. For example, with reference to FIG. 6, the timer data 632 obtained by the timing system 642 can be used to determine when the frames per second metric was determined to be out of range. By answering the question of “when” a game's performance dropped out of tolerance, the testing framework 640, via a test script 630 that may include conditionals, can act to additionally determine the “how” and “why” that cause the unacceptable performance (e.g., what caused the performance to suffer).

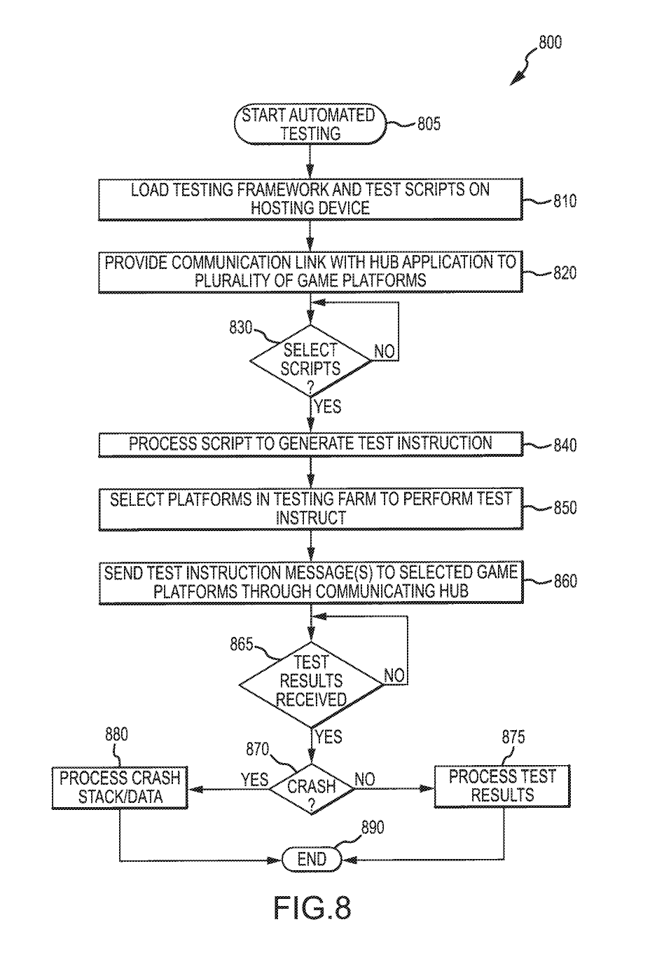

With the above descriptions in mind, it may be useful now to discuss an automated testing method and how the use of test scripts and external/remote testing may be accomplished. FIG. 8 is a flow chart illustrating steps or processes carried out in an exemplary automated testing method 800 such as may be carried out by operation of the testing system of FIGS. 6 and 7. At 805, the automated testing begins such as with planning one or more tests to run upon a video game that is under development such as to check stability by rebooting the game on differing platforms (e.g., can the game start without crashing), by loading various new/modified levels, by loading characters, and so on. The game planning or design at 805 may also include establishing a testing farm with a number of game platforms or consoles that are to be used in the testing. For example, the testing farm may include at least one game console or platform that corresponds to each device for which the game software is being developed such as one console for each major game console distributor and typically two or more of each type of console (e.g., to allow a test or testing step to be distributed over these multiple game platforms).

The method 800 continues at 810 with providing a test-hosting computer system. Step 810 involves loading a testing framework upon this host computer and also involves storing one or more test scripts in memory of the host computer or providing the scripts in a way that is accessible to the testing framework (e.g., on a networked server or the like). Again, the test scripts may be written relatively generically but with the use of the communications hub application can be provided to a game on nearly any type of game platform. The test scripts may be relatively simple (e.g., include one to two commands such as reboot a particular game, load a particular character/game element, and so on) or be much more complex (e.g., include two to many test functions including reactive routines or conditionals). At step 820, the method 800 includes providing a communications link with a server running a communications hub application adapted for communicating with each of the game platforms in the testing farm (e.g., reformatting test messages from the testing framework to a form/format expected by each game platform).

At 830, the method 800 continues with a tester operating the hosting computer system to select a test script to initiate a next test run. At 840, the selected test script is processed (such as by a scripting module of the testing framework) to generate a set of test instructions or orders. At 850, the method 800 includes determining one or more of the game platforms in the testing farm to carry out the scripted test. This step may be carried out at least partially manually with a distribution module first determining through a query of the testing farm the makeup of the testing farm and which game platforms are available for use in this test. This available set of game platforms may be presented to a tester at step 850, such as in a testing GUI or the like, and the tester may be able to select one or more of the platforms/consoles to perform each of the testing instructions (e.g., a “selected test subset” of the game platforms).

In other cases, though, the distribution or automation module may act automatically to select and assign the various game platforms of the testing farm to most efficiently carry out the test. For example, the testing instructions may require that a new game be rebooted upon every target-type of game platform, and the distribution module may identify one of each type of game platform in the testing farm to simultaneously carry out the test (e.g., each type of platform is selected to carry out the same test function “reboot the new game”). In another example, the game may have a plurality of levels and the instruction of the test may be to load each of these levels. In this case, the distribution module may identify a number of game consoles available in each category or type (e.g., 3 Playstation® consoles, 4 Xbox® consoles, and the like), and then act to distribute the load over the available game platforms (e.g., the game has 12 levels and each of the 3 Playstation® consoles is used to load 4 levels while each of the 4 Xbox® consoles is used to load 3 levels). In each of these ways, the test is run much more efficiently (quickly) such that the results can be obtained in a fraction of the time required if only one console/platform were utilized or test steps were performed sequentially across the differing platform types.

At step 860, the method 800 includes sending the test instruction message or messages to selected game platforms through the communications hub. At 865, the method 800 includes waiting for communication of test results back from the games (e.g., from an automation/communications manager layer on each video game running in the testing farm). Although not shown, a timer module in the testing framework may track the time the message was sent in step 860 and, if no results are received at 865 within a predefined time period, the testing framework may tally a failure for the test or test instruction sent at 860 (e.g., after sending a reboot command, timeout after a preset time has passed and report failure of test/test function to tester running the test).

At 870, when results/test data is received at 865, a determination is made whether the received data is indicative of a crash. If not, the method 800 continues with the testing framework processing the test results at 875 (e.g., generating a graph of FPS data over a test run period to show performance over time/over particular levels or game play). If a crash has occurred, at 880, the method 800 continues with a crash tracking module processing the results data, which may include a crash stack or the like obtained from the automation/communication manager running on the game on the particular game platform. At 890, the automated testing method 800 may end or the method 800 may continue at 830 with an additional test script being selected.

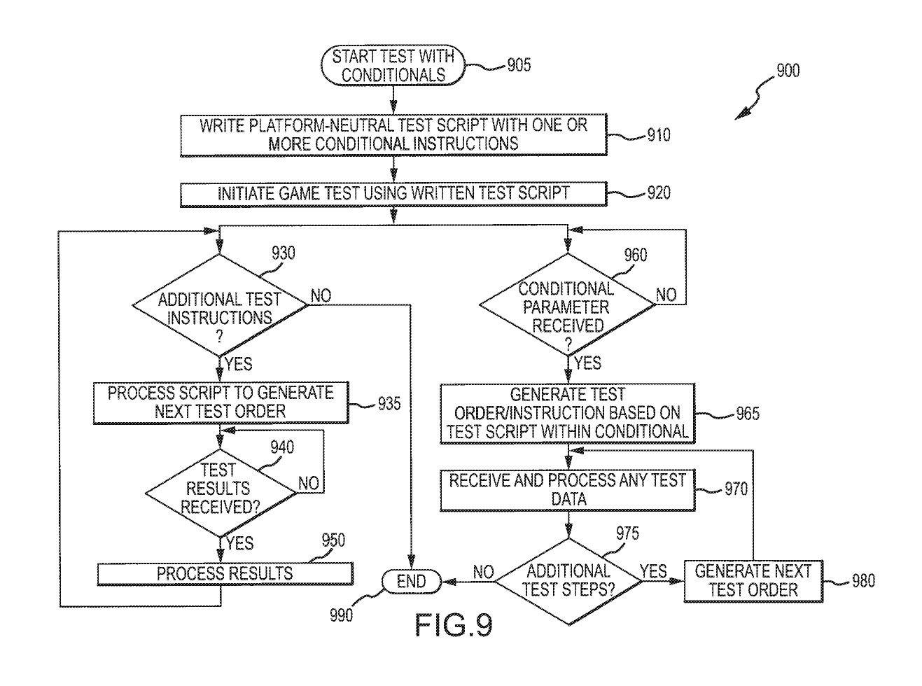

FIG. 9 is a flow chart showing the processes of an exemplary conditional or reactive game testing method 900 using bi-directional communications to perform a software test of game software under development from an external or remote test-hosting computer system. At 906, the test is started and this may include planning a reactive test or reactive portion of a test. For example, a test may be designed that checks a games stability on a platform by incrementally loading additional characters or game elements that have to be rendered and requires more and more processing and memory resources. As each character/element is loaded, a conditional may be checked to determine whether the game is still stable or performing above minimal performance/test limits (e.g., is FPS metric greater than 30 FPS after addition of new character/game element?).

At 910, the method 900 is shown to include writing (or simply retrieving/obtaining) a platform-neutral test script with one or more conditional instructions. For example, a game/platform metric may be compared against a predefined test limit or minimum performance value or a conditional may involve determining whether a prior test function/order was successful (e.g., load of “x” successful or failed). At 920, the written or retrieved test script is used to initiate a game testing from an external observer/host PC (e.g., with a testing framework linked to a testing farm as shown in FIG. 6).

At 930, the method 900 continues with determining Whether there are additional test instructions (or if a test length has not yet expired as some test instructions may require a test be performed for a certain time period to test stability). If no more instructions to perform, the test method 900 may end at 990. If there is more testing to be completed, the test method 900 proceeds at 935 with processing the test script to generate a next text order or instruction that is then sent to the game platform(s) being used in the test. For example, a test may call for a first step of rebooting a game, then loading various levels, then loading characters/game objects, retrieving screen shots, and other test steps/functions in sequential order (e.g., would only load a next level after the game is rebooted and running on a game platform and the like). At 940, the testing method 900 includes the testing framework waiting for test results/data, and then at 950, processing any received results to provide a test report/output that may include sending alerts with test data/results (“Load of Level 4 failed,” “FPS fell below 30 FPS” at particular point in the game, and the like) and/or providing test results in graphical/tabular or other forms (such as in a GUI, in email/text or other messages, and so on).

Concurrently with steps 930-950, the method 900 includes waiting for receipt of conditional parameters at 960. For example, the frames per second may periodically be received from one or more games or an instruction/order may query whether a test instruction issued at 935 was successful (e.g., is load character=false?). At 965, the method 900 includes determining that the conditional parameter value triggers a conditional such as a metric below a test/performance limit, a conditional parameter that is true or false (depending how the conditional is written), and the like. If so, in 965, the method 900 includes generating a test order or instruction based on a test script within the conditional. For example, the conditional parameter may be whether the FPS metric is less than 30 FPS, and, when this conditional is true, a next instruction may be to retrieve full CPU usage. In another example, the conditional may be to determine whether a character failed to load, and, if so, to then generate a memory report for the game platform.

At 970, the method 900 may then include receiving and processing the test data associated with the next instruction/order of step 965. Then, at 975, it is determined whether there are additional steps/functions within the conditional. If not, the method 900 ends at 990 or continues at 930 and 960. If yes, at 980, the method 900 continues with generating a next test order. In the FPS metric example, additional instructions may include obtaining a memory report, determining how many characters are on the screen, generating a screen shot, and the like. In the load character example, additional instructions may include generating a character manager report, obtaining a screen shot, determining full CPU usage, or performing other steps useful in troubleshooting a failure to properly load an additional game character. The method 900 then continues at 970 with processing this additional test/troubleshooting data.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, the automated testing system may translate the test data received from a crashed game platform into a call stack in an automated and non-manual or unsupervised manner so as to allow programmer to quickly identify and review this information that may be very important for identifying the where and why of a crash caused by executing/running game code.

We claim:

1. A video game testing system for externally testing game software, comprising:
a testing farm comprising a plurality of game platforms adapted to run a video game;
a communications hub communicatively linked with the game platforms;
a set of test scripts stored in memory, each of the test scripts defining a number of test functions to be performed on the game platforms; and
a testing framework running on a computer system communicatively linked with the communications hub, the testing framework selecting one of the test scripts and transmitting test messages to a subset of the game platforms, wherein the test messages are configured based on a client-side communications library providing communication protocols for the communications hub module and wherein the communications hub module receives the test messages and generates game platform test messages from the received messages based on communication libraries for the game platforms.

2. The system of claim 1, wherein the game platforms comprise game consoles of at least two hardware and software configurations and wherein the test scripts are neutral with reference to the hardware and software configurations.

3. The system of claim 1, wherein the testing framework receives test data, corresponding to performance of the test functions of the selected test script, from one of the game platforms via the communication hub and wherein the testing framework verifies completion of one or more of the test functions by processing the received test data.

4. The system of claim 3, Wherein the selected script includes a conditional including a parameter provided in the received test data and wherein the testing framework issues an additional test message in response to the parameter satisfying the conditional requesting additional test data from one of the game platforms.

5. The system of claim 1, wherein each of the game platforms includes a test communication module communicatively linking the video game with the testing framework.

6. The system of claim 1, wherein the subset of the game platforms receiving the test messages includes at least two of the game platforms that function to concurrently perform one or more of the test functions and report test data based on the test function performing to the testing framework.

7. The system of claim 6, wherein the at least two game platforms have differing hardware or software configurations and wherein the test messages cause like ones of the test functions to be performed on the game platforms, whereby an automated test is repeated within the testing farm.

8. The system of claim 6, wherein the at least two game platforms have matching hardware and software configurations and wherein the test messages received by the at least two game platforms cause differing ones of the test functions to be concurrently performed, whereby an automated test is distributed over the testing farm.

9. A method for testing a video game, comprising:
providing a testing framework run by a processor of a test-hosting computer;
generating a test instruction defining a test function for the video game with the testing framework;
transmitting a message including the test instruction to a set of game platforms running the video game and communicatively linked to the testing framework; and
receiving from each of the game platforms test data corresponding to performance of the test instruction.

10. The method of claim 9, wherein the received test data indicates whether the test function failed on each of the game platforms.

11. The method of claim 9, wherein the received test data includes crash data retrieved from one of the game platforms.

12. The method of claim 9, wherein the test instruction includes a conditional and the received test data includes a value for a parameter of the conditional and wherein the testing framework processes the conditional with the parameter value and, in response, generates and transmits an additional test instruction to the game platform transmitting the conditional parameter value to gather and return additional performance data.

13. The method of claim 9, wherein the generating of the test instruction includes generating at least two sub-instructions defining a portion of the test function and wherein the set of game platforms includes at least two of the game platforms each receiving one of the sub-instruction, whereby the test function is distributed over the game platforms for at least partially concurrent performance.

14. The method of claim 9, wherein the set of game platforms include at least two types of consoles with differing software or hardware configurations, whereby the test function is concurrently performed on two or more differing types of game platforms.

15. The method of claim 9, wherein the testing framework tracks timing of testing events including the message transmitting and the receiving of the game data and wherein the testing framework tallies the test function as a failure when communications between the test-hosting computer and one of the game platforms is interrupted.

16. A system for testing video games, comprising:
a plurality of video game platforms running a video game; and
a test-hosting computer system communicatively linked to each of the game platforms and providing a testing framework,
wherein the testing framework processes a test script defining a set of test processes for the video game and, in response, transmits messages including test instructions corresponding to the test processes to the game platforms and
wherein an automation module is provided on each of the game platforms to communicate test data gathered by performing one of the test processes to the testing framework.

17. The system of claim 16, wherein the video game platforms comprise at least two differing types of game consoles and wherein the test script is console type neutral.

18. The system of claim 16, wherein the set of test processes defined by the test script includes at least two actions including at least one of reboot the video game, load a level of the video game, add a character or game element to the video game, provide a memory report, capture a screen shot, provide full processor usage, and determine total number of characters or game elements on screen.

19. The system of claim 16, wherein the test instruction messages are transmitted to a subset of the game platforms and wherein each of the subset of game platforms is instructed to perform a differing portion of the test processes, whereby a test is performed in a distributed manner.

20. The system of claim 16, wherein the testing framework includes a timing system tracking timing of the message transmitting and, in response, receiving test data from the game platforms, and further wherein the testing framework tallies a test as a failure when a time period expires as determined based on the timing tracking.
